(19) United States
(12) Patent Application Publication
(10) Pub. No.: US 2024/0220612 A1
(43) Pub. Date: Jul. 4, 2024

(54) METHODS AND APPARATUS FOR DISARMING JAVASCRIPT IN PDF OR HWP

(71) Applicant: SECULETTER CO., LTD., Seongnam-si, Gyeonggi-do (KR)

(72) Inventor: Chang Seok YOO, Seongnam-si (KR)

(73) Assignee: SECULETTER CO., LTD., Seongnam-si, Gyeonggi-do (KR)

(21) Appl. No.: 17/780,139

(22) PCT Filed: May 25, 2022
(86) PCT No.: PCT/KR2022/007429

§ 371 Date: Nov. 30, 2023

(51) Int. Cl. G06F 21/55; G06F 40/197

(52) U.S. Cl. CPC G06F 21/554; G06F 40/197

(57) ABSTRACT

This specification relates to a method of disarming, by a server, a non-portable executable (non-PE) file. The method may include determining a document format of the non-PE file, searching for a dictionary type of the non-PE file on the basis of basic elements of the non-PE file by circulating throughout the non-PE file, based on the document format being a PDF, inspecting whether a JS entry is included in the dictionary type, and substituting a value of the JS entry with an empty string by comparing the value of the JS entry with the empty string.

### TECHNICAL FIELD

This specification relates to a method and apparatus for disarming JavaScript in a portable document format (PDF) or an HWP format.

### BACKGROUND ART

In an advanced persistent threat (APT) attack, in order for an attacker to determine a specific target and steal targeted information, various types of malware are persistently used by applying a high-level attack scheme.

In particular, an APT attack is not detected at an initial intrusion stage in many cases. A non-portable executable (non-PE) file including malware is chiefly used in the APT attack.

A method of inspecting whether a non-PE file is malicious includes a signature-based inspection method. The signature-based inspection method is a method of inspecting whether a non-PE file includes a signature of malware. However, most of malicious non-PE files avoid such diagnosis by including malware in a script, such as JavaScript or a macro script, or encoding a script according to circumstances. It is difficult to know which script is included in a non-PE file itself. Accordingly, it is almost impossible to properly inspect whether a non-PE file is malicious by using the existing signature-based inspection method.

### DISCLOSURE

### Technical Problem

Various embodiments are directed to proposing a method of disarming JavaScript while maintaining the entire structure of a PDF and an HWP format.

Technical objects be to achieved by this specification are not limited to the aforementioned object, and the other objects not described above may be evidently understood from the following detailed description of the specification by a person having ordinary knowledge in the art to which this specification pertains.

### Technical Solution

In an embodiment, a method of disarming, by a server, a non-portable executable (non-PE) file may include determining a document format of the non-PE file, searching for a dictionary type of the non-PE file on the basis of basic elements of the non-PE file by circulating throughout the non-PE file, based on the document format being a PDF, inspecting whether a JS entry is included in the dictionary type, and substituting a value of the JS entry with an empty string by comparing the value of the JS entry with the empty string.

Furthermore, the basic element may be an “obj” entity, and the dictionary type may include a JavaScript action entity.

Furthermore, the method may further include identifying a first stream or a second stream, that is, the target of the disarming, based on the document format being an HWP format, determining a compression and storage state of the first stream or the second stream, and comparing the first stream or the second stream with a basic value based on the compression and storage state and substituting the first stream or the second stream with the basic value.

Furthermore, the first stream may be a DefaultJScript stream, and the second stream may be a JScriptVersion stream.

Furthermore, the first stream may include a JavaScript code, and the second stream may include version information of the JavaScript.

Furthermore, the basic value may be a value corresponding to the first stream or second stream of a new document having the HWP format.

Furthermore, the basic value may have the same compression and storage state as a value of the first stream and/or the second stream.

In another embodiment, a server for disarming a non-portable executable (non-PE) file may include a communication unit, a memory comprising a contents disarm and reconstruction (CDR) engine for performing the disarming, and a processor configured to functionally control the communication unit and the memory. The processor may be configured to determine a document format of the non-PE file, search for a dictionary type of the non-PE file on the basis of basic elements of the non-PE file by circulating throughout the non-PE file, based on the document format being a PDF, inspect whether a JS entry is included in the dictionary type, and substitute a value of the JS entry with an empty string by comparing the value of the JS entry with the empty string.

### Advantageous Effects

According to an embodiment of this specification, the disarming of JavaScript can be performed while maintaining the entire structure of a PDF and an HWP format.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a diagram illustrating a server or a client related to this specification.

FIG. 2 is an example of an abnormal input which may be applied to this specification.

FIG. 3 exemplifies a disarming method to which this specification may be applied.

FIG. 4 exemplifies a method of disarming a PDF file to which this specification may be applied.

FIG. 5 exemplifies a method of disarming an HWP file to which this specification may be applied.

The accompany drawings, which are included as part of the detailed description in order to help understanding of this specification, provide embodiments of this specification and describe the technical characteristics of this specification along with the detailed description.

### MODE FOR INVENTION

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “ . . . unit” used in this specification means a software or hardware element, and the “ . . . unit” performs specific tasks. However, the term “ . . . unit” does not mean that it is limited to software or hardware. The “ . . . unit” may be configured to reside on an addressable storage medium and configured to operate one or more processors. Accordingly, examples of the “ . . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, arrays, and variables. The functionalities provided in the elements and the “ . . . units” may be combined into fewer elements and “ . . . units”, or may be further separated into additional elements and “ . . . units”.

Furthermore, “ . . . unit” according to an embodiment of this specification may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC), a programmable logic device (PLD), a field programmable gate array (FPGA), etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may be in the electronic communication state with the processor.

The concept of a “non-PE file” used in this specification is opposite to the concept of a PE file or an executable file, and the “non-PE file” means a file that is not autonomously executed. For example, the non-PE file may be a document file such as a PDF file, a Hangul file, or a MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

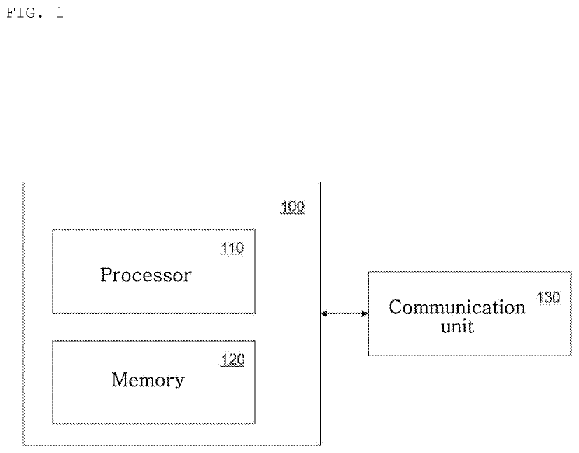

FIG. 1 is a diagram illustrating a server or a client related to this specification.

In this specification, the server (or a cloud server) or the client may include a controller 100 and a communication unit 130. The controller 100 may include a processor 110 and a memory 120. The processor 110 may perform instructions stored in the memory 120. The processor 110 may control the communication unit 130.

The processor 110 may control an operation of the server or the client based on an instruction that is stored in the memory 120. The server or the client may include one processor, or may include a plurality of processors. If the server or the client includes a plurality of processors, at least some of the plurality of processors may be disposed at places that are physically spaced apart from each other. Furthermore, the server or the client is not limited thereto, and may be implemented by using various known methods.

The communication unit 130 may include one or more modules that enable wireless communication between the server or the client and a wireless communication system, between the server or the client and another server or client, or between the server or the client and an external server. Furthermore, the communication unit 110 may include one or more modules that connect the server or the client to one or more networks.

The controller 100 may control at least some of the elements of the server or the client in order to drive an application program that is stored in the memory 120. Moreover, the controller 100 may combine and drive at least two of the elements that are included in the server or the client in order to drive the application program.

In this specification, the server may include a reversing engine or/and a contents disarm and reconstruction (CDR) engine that provides CDR services.

### Reversing Engine

A reversing engine is an analysis/diagnosis engine obtained by automating a reverse engineering (reversing) process for a malicious non-PE file.

For example, the reversing engine may perform the following steps.

1. File analysis: this is a step of analyzing an appearance (e.g., properties, an author, a date created, or a file type) of a non-PE file itself. In this step, whether a non-PE file is malicious may be diagnosed based on only information of the non-PE file itself like a common vaccine program.

2. Static analysis: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for a macro, the extraction and analysis of a URL, etc.

3. Dynamic analysis: this is a step of determining whether a non-PE file is malicious by analyzing an act of the non-PE file while executing and monitoring the non-PE file. If this step is used, a malicious act using a normal function, such as a macro, a hyperlink, or DDE, can be easily detected.

4. Debugging analysis: this is a step of analyzing vulnerability, exploits, etc. by executing and debugging a non-PE file. This step is suitable for detecting the non-PE file. vulnerability of an application program using a body, a table, a font, a picture, etc. within a document, including a macro, a hyperlink, or DDE.

The reversing engine may include a debugging engine which may be used in debugging analysis. The debugging engine can diagnose vulnerability which occurs in a document input, processing, and output stage by debugging a process of reading a non-PE file. In this case, the vulnerability relates to an error, a bug or the like, which occurs when an application program receives an unexpected value in a code (or logic) developed by a developer of the application program. An attacker may execute a malicious document act, such as the denial of service attributable to abnormal termination or the remote execution of a code, through the vulnerability.

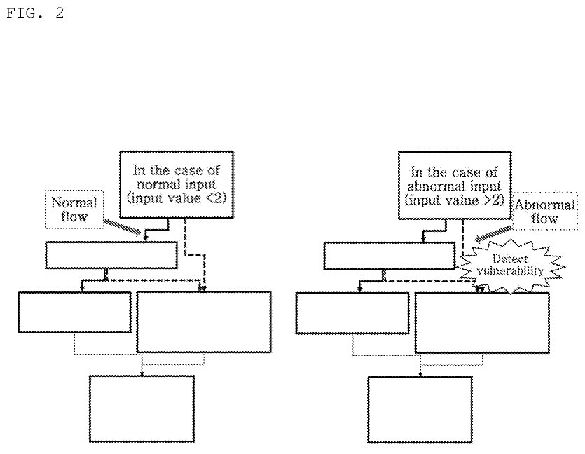

FIG. 2 is an example of an abnormal input which may be applied to this specification.

Referring to FIG. 2, when receiving an abnormal value (e.g., when an input value is greater than 2, that is, a normal range) through a non-PE file, an execution flow of an application program changes into an execution flow not intended by a developer, so that vulnerability may occur. The debugging engine may set a break point at a specific point that is related to the vulnerability by automatically debugging a document reading process, may check the specific value related to the input value, and may diagnose whether the non-PE file is malicious by determining whether the input value is a value that causes the vulnerability.

More specifically, the debugging engine may start debugging by checking the non-PE file and executing the application program for reading the non-PE file. When a module is loaded in the process of reading the non-PE file, the debugging engine may check whether the corresponding module is an analysis target module, and may set the break point at a designated address when the corresponding module is an analysis target.

For example, a malicious non-PE file may have branch points at which an application program is terminated or a flow of the application program branches into a flow in which any malicious act does not occur when a version of the application program or a specific condition, such as an operating system environment, is not satisfied. The server may set a break point at a branch point that is previously analyzed by an analyst and that has such a possibility.

Furthermore, the server may set conditions on which the server may continue to execute the application program without terminating the application program or may induce a flow of the application program into a flow in which a malicious act may occur, in association with a corresponding branch point.

If a process of the application program is stopped at a corresponding break point during the process, the server may perform a step of detecting the occurrence of vulnerability through detection logic and then storing the results of the detection in an analysis report.

The automation reversing engine that is included in the server can diagnose and block a malicious non-PE file through a diagnosis algorithm researched and developed by an analyst, by analyzing the aforementioned steps while automatically performing the aforementioned steps.

### Contents Disarm and Reconstruction (CDR)

A CDR service is a solution that generates a new file by decomposing a non-PE file, removing a malicious file or an unnecessary file from the non-PE file, and making content therein identical with the original as much as possible.

That is, CDR means a service that generates a safe document by disarming and reconstructing content within a document and that provides the safe document to a customer. A disarming target file may include all non-PE files (e.g., a MS Word, Excel, PowerPoint, a Hangul, and a PDF). Disarming target content may be active content (e.g., a macro, a hyperlink, and an OLE object).

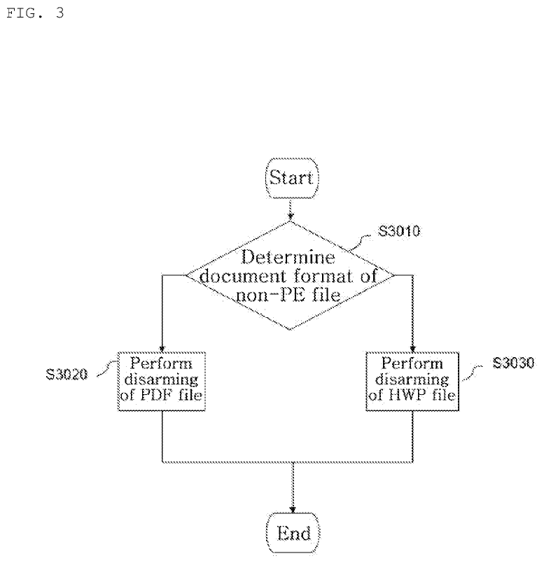

FIG. 3 exemplifies a disarming method to which this specification may be applied.

Referring to FIG. 3, the server may determine a document format of a non-PE file (S3010). For example, in order to determine the document format of the non-PE file, the server may open the non-PE file, and may identify the document format by identifying a signature type on a binary code.

For example, each of non-PE files has a unique format. Basic contents of the format are a file signature. In the file signature, specific bytes that are disposed in the first place of the file may also be used to identify the format of the file.

For example, an HWP file may have a signature of “D0 CF 11 E0 A1 B1 1A E1”, and a PDF file may have a signature of “25 50 44 46.”

The server may perform the disarming of a PDF file (S3020) when determining the format of the non-PE file as the PDF file, and may perform the disarming of an HWP file (S3030) when determining the format of the non-PE file as an HWP file.

In this specification, a JavaScript disarming method is described as an example, but the present disclosure may also be similarly applied to the disarming of an object-based script language (macro) having a format similar to JavaScript. For example, HWP has a Macro function, and Macro may be implemented in a JavaScript language.

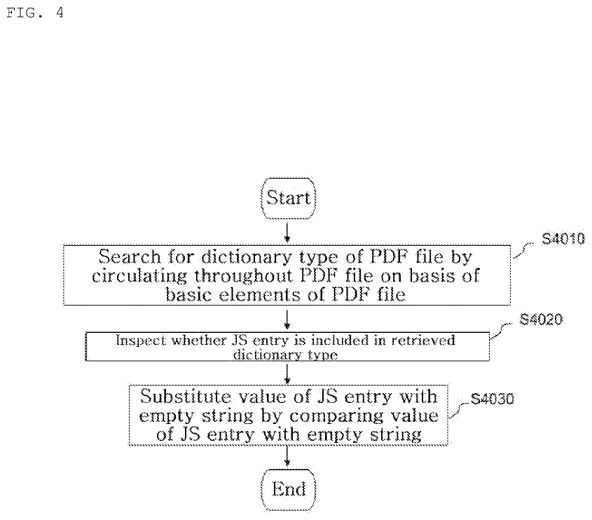

FIG. 4 exemplifies a method of disarming a PDF file to which this specification may be applied.

FIG. 4 exemplifies a method of disarming a PDF file when the server determines the format of a non-PE file as the PDF file.

The server searches for a dictionary type of a PDF file by circulating throughout the PDF file on the basis of basic elements of the PDF file (S4010). For example, the server may circulate throughout the PDF file on the basis of “obj” as a basic element of the PDF file. An actual role and function of a corresponding element may be defined based on a value that is set in the basic element “obj”.

In the case of a common method of checking an element within each page by circulating throughout the page on the basis of each page, there is a danger that except processing may be omitted because many exceptions, such as that an Action obj circulates and refers to itself in an actual document, may be present.

For example, in the case of the PDF, circulating throughout a PDF file on the basis of “obj” is stable even in terms of time complexity because an indirect “obj” is frequently referred to.

Furthermore, a redundant search problem also needs to be taken into consideration because one “obj” may be referred to in several pages. A method of circulating throughout a file on the basis of “obj” can guarantee search for all “objs” through one round trip because it is possible to circulate throughout all “objs” of a certain document.

Such “obj” may have a dictionary type. For example, the dictionary type is one of eight types of basic data formats (i.e., Boolean values, Integer and Real numbers, Strings, Names, Arrays, Dictionaries, Streams, and the null object), and may include one entry having a pair of {key}-{value} corresponding relations.

The server inspects whether a JS entry is included in the retrieved dictionary type (S4020).

For example, the dictionary type may include a JavaScript action entity. For example, when invoking in order of “Obj→Array→Dictionary→Action”, the server may determine that a corresponding “obj” is JavaScript Action having a simple form.

Table 1 below is an example of the JavaScript action entity.

```
TABLE 1
○ 62 0 obj
  << /JS (app.alert(″JS TEST″);) /Next 63 0 R /S/JavaScript>
  endobj
```

Referring to Table 1, the form “<< >>” means the dictionary type. The dictionary type may consist of three entries including JS, Next, and S. The server substitutes a JS entry with an empty string by comparing a value of the JS entry with the empty string (S4030). For example, when the value of the JS entry is not the empty string, the server may substitute the JS entry with the empty string.

Table 2 below exemplifies the results of the value of the JS entry that has been substituted with the empty string in Table 1.

TABLE 2

```
○ 62 0 obj
  << /JS ( ) /Next 63 0 R /S/JavaScript>>
  endobj
```

If the server removes an essential element, a Next Action operation connected to JavaScript Action may not be performed. Accordingly, the server can accurately perform disarming on only the target of removal without affecting another function by substituting the value of the JS entry with the empty string. Accordingly, the server can perform disarming on only changed contents of JavaScript while maintaining the entire structure of a document without any change.

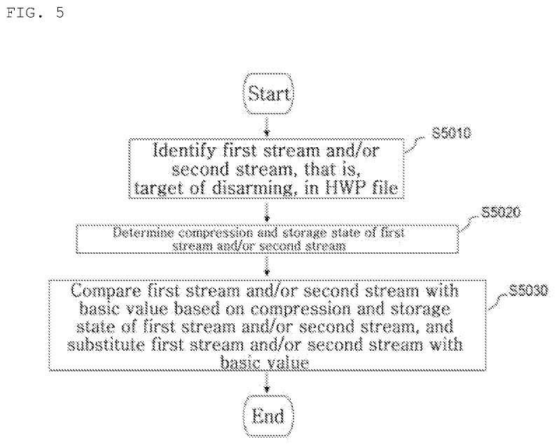

FIG. 5 exemplifies a method of disarming an HWP file to which this specification may be applied.

FIG. 5 exemplifies a method of disarming an HWP file when the server determines the format of a non-PE file as an HWP file.

A directory and file structure of a CFB-series file including an HWP file may be identified by decompressing the CFB-series file. In this case, a directory form is called storage, and a file form is called a stream.

Table 3 below exemplifies the structure of a common HWP file.

TABLE 3

```

[symbol]
Scripts [symbol]
  JScriptVersion [symbol]
  DefaultJScript [symbol]
DocOptions [symbol]
  _LinkDoc [symbol]
BodyText [symbol]
  Section0 [symbol]
PrvText [symbol]
PrvImage [symbol]
FileHeader [symbol]
DocInfo [symbol]
[5]HwpSummaryInformation
```

Referring to Table 3, the HWP file includes a DefaultJScript stream and a JScriptVersion stream.

### DefaultJScript Stream

In this specification, the DefaultJScript stream is a JavaScript disarming target, and may be a file in which a JavaScript code has been stored.

### JScriptVersion Stream

In this specification, the JScriptVersion stream is a JavaScript disarming target, and may be a file in which JavaScript Version information has been stored.

Such streams may be compressed and stored (e.g., a zlib method) in order to reduce a file size.

The server identifies a first stream and/or a second stream, that is, targets of disarming, in the HWP file (S5010). For example, the first stream may be the DefaultJScript stream, and the second stream may be the JScriptVersion stream.

The server determines a compression and storage state of the first stream and/or the second stream (S5020). For example, the server may determine whether the first stream or the second stream has been compressed by extracting header information of the first stream and/or the second stream.

The server compares the first stream and/or the second stream with a basic value based on the compression and storage state of the first stream and/or the second stream, and substitutes the first stream and/or the second stream with the basic value (S5030). For example, the basic value may mean a value corresponding to corresponding stream of a new HWP document.

More specifically, if the first stream and/or the second stream are in the state in which the first stream and/or the second stream have been compressed and stored, the basic value may be a value of the first stream and/or second stream of the new HWP document, which have been compressed.

If the first stream and/or the second stream are in the state in which the first stream and/or the second stream have not been compressed and stored, the basic value may be a value of the first stream and/or second stream of the new HWP document, which have not been compressed.

That is, the basic value may have the same compression and storage state as the value of the first stream and/or the second stream.

Table 4 below exemplifies basic values which may be applied to this specification.

TABLE 4

| | | | | | | | | | | | | | | | | | |
|---|---|---|---|---|---|---|---|---|---|---|---|---|---|---|---|---|---|
| Basic value of | Offset (h) | 00 | 01 | 02 | 03 | 04 | 05 | 06 | 07 | 08 | 09 | 0A | 0B | 0C | 0D | 0E | 0F |
| common | 00000000 | 01 | 00 | 00 | 00 | 00 | 00 | 00 | 00 | | | | | | | | |
| JScriptVersion | | | | | | | | | | | | | | | | | |
| Basic value of | Offset (h) | 00 | 01 | 02 | 03 | 04 | 05 | 06 | 07 | 08 | 09 | 0A | 0B | 0C | 0D | 0E | 0F |
| common | 00000000 | 00 | 00 | 00 | 00 | 00 | 00 | 00 | 00 | 00 | 00 | 00 | 00 | 00 | 00 | 00 | 00 |
| DefaultVersion | 00000010 | FF | FF | FF | FF | | | | | | | | | | | | |
| Basic value of | Offset (h) | 00 | 01 | 02 | 03 | 04 | 05 | 06 | 07 | 08 | 09 | 0A | 0B | 0C | 0D | 0E | 0F |
| compressed | 00000000 | 63 | [symbol] | [symbol] | 00 | 00 | [symbol] | [symbol] | [symbol] | [symbol] | [symbol] | 00 | 00 | [symbol] | | | |
| JScriptVersion | | | | | | | | | | | | | | | | | |
| Basic value of | Offset (h) | 00 | 01 | 02 | 03 | 04 | 05 | 06 | 07 | 08 | 09 | 0A | 0B | 0C | 0D | 0E | 0F |
| compressed | 00000000 | 63 | [symbol] | [symbol] | [symbol] | [symbol] | [symbol] | 00 | 00 | [symbol] | [symbol] | [symbol] | [symbol] | [symbol] | 00 | 00 | 00 |
| DefaultVersion | | | | | | | | | | | | | | | | | |

[symbol]

indicates data missing or illegible when filed

When there is a difference between the first stream and/or the second stream and the basic value as a result of the comparison, the server may substitute the first stream and/or the second stream with the basic value. Accordingly, the server may perform disarming on the basis of the basic value without unconditionally removing a disarming target stream or generating the disarming target stream as an empty file. This has an effect in that the possibility of an error which may occur in an original document is reduced.

Furthermore, the server may determine whether a Javascript code has been actually inserted and edited by comparing a disarming target with a basic value, such as an empty string. Accordingly, the server can easily determine malware.

The aforementioned present disclosure may be implemented in a medium on which a program has been recorded as a computer-readable code. The computer-readable medium includes all types of recording devices in which data readable by a computer system is stored. Examples of the computer-readable medium include a hard disk drive (HDD), a solid state disk (SDD), a silicon disk drive (SDD), ROM, RAM, CD-ROM, a magnetic tape, a floppy disk, an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

1. A method of disarming, by a server, a non-portable executable (non-PE) file, the method comprising:
determining a document format of the non-PE file;
searching for a dictionary type of the non-PE file on the basis of basic elements of the non-PE file by circulating throughout the non-PE file, based on the document format being a PDF;
inspecting whether a JS entry is included in the dictionary type; and
substituting a value of the JS entry with an empty string by comparing the value of the JS entry with the empty string.

2. The method of claim 1, wherein:
the basic element is an “obj” entity, and
the dictionary type comprises a JavaScript action entity.

3. The method of claim 1, further comprising:
identifying a first stream or a second stream, which is a target of the disarming, based on the document format being an HWP format;
determining a compression and storage state of the first stream or the second stream; and
comparing the first stream or the second stream with a basic value based on the compression and storage state and substituting the first stream or the second stream with the basic value.

4. The method of claim 3, wherein:
the first stream is a DefaultJScript stream, and
the second stream is a JScriptVersion stream.

5. The method of claim 3, wherein:
the first stream comprises a JavaScript code, and
the second stream comprises version information of the JavaScript.

6. The method of claim 3, wherein the basic value is a value corresponding to the first stream or second stream of a new document having the HWP format.

7. The method of claim 6, wherein the basic value has a compression and storage state identical with a compression and storage state of a value of the first stream and/or the second stream.

8. A server for disarming a non-portable executable (non-PE) file, comprising:
a communication unit;
a memory comprising a contents disarm and reconstruction (CDR) engine for performing the disarming; and
a processor configured to functionally control the communication unit and the memory,
wherein the processor is configured to determine a document format of the non-PE file, search for a dictionary type of the non-PE file on the basis of basic elements of the non-PE file by circulating throughout the non-PE file, based on the document format being a PDF, inspect whether a JS entry is included in the dictionary type, and substitute a value of the JS entry with an empty string by comparing the value of the JS entry with the empty string.
